(19) United States
(12) Patent Application Publication
(10) Pub. No.: US 2008/0188293 A1
(43) Pub. Date: Aug. 7, 2008

(54) Wagering Game Machine with Transmissive Lcd Lighting

(76) Inventors: James M. Rasmussen, Chicago, IL (US); Thomas M. Kopera, Villa Park, IL (US); Stephen A. Canterbury, Antioch, IL (US)

Correspondence Address: SCHWEGMAN, LUNDBERG & WOESSNER/WMS GAMING, P.O. BOX 2938, MINNEAPOLIS, MN, 55402, US

(21) Appl. No.: 11/914,829

(22) PCT Filed: May 18, 2006
(86) PCT No.: PCT/US2006/019045

§ 371 Date: Nov. 19, 2007

Related U.S. Application Data
(60) Provisional application No. 60/682,162, filed on May 18, 2005.

(51) Int. Cl. A63F 13/00

(52) U.S. Cl. 463/25; 463/31

(57) ABSTRACT

A computerized wagering game system includes a gaming module comprising a processor and gaming code which is operable when executed on the processor to present a wagering game on which monetary value can be wagered via at least one mechanical reel and a liquid crystal display (LCD). The liquid crystal display has at least one transparent portion through which the mechanical reel or reels can be observed. A light source is configured to illuminate a back side of the at least one transparent portion of the LCD panel, selectively highlighting images shown on the transparent portion or portions of the LCD display panel.

### RELATED APPLICATION

This application claims the priority benefit of U.S. Provisional Application Ser. No. 60/682,162 filed May 18, 2005, the contents of which are incorporated herein by reference.

### FIELD OF THE INVENTION

The invention relates generally to computerized wagering game machines, and more specifically to lighting transmissive lcd panels in computerized wagering game machines.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, WMS Gaming, Inc.

### BACKGROUND

Computerized wagering games have largely replaced traditional mechanical wagering game machines such as slot machines, and are rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

The elements of computerized wagering game systems are in many ways the same as the elements in the mechanical and table game counterparts in that they must be fair, they must provide sufficient feedback to the game player to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games do not rely on the dealer or other game players to facilitate game play and to provide an entertaining game playing environment, but rely upon the presentation of the game and environment generated by the wagering game machine itself. Incorporation of audio and video features into wagering games to present the wagering game, to provide help, and to enhance the environment presented are therefore important elements in the attractiveness and commercial success of a computerized wagering game system. It is not uncommon for audio voices to provide instruction and help, and to provide commentary on the wagering game being played. Music and environmental effects are also played through speakers in some wagering game systems to enhance or complement a theme of the wagering game. These sounds typically accompany video presentation of the wagering game on a screen, which itself often includes animation, video, and three-dimensional graphics as part of presentation of the wagering game.

But, many people prefer to see mechanical reels rather than video rendering of a slot machine game, in part due to the more traditional appearance of the rotating slot reels. Presentation of mechanical reels makes the wagering game more enjoyable for some of these people, and so mechanical reel slot machines are still common in many wagering game facilities. But, use of reel slot machines limits the ability of a wagering game machine to present computer graphics and animation to enhance the theme of the wagering game or to provide other information, and so are often less entertaining than LCD (liquid crystal display) touchscreen wagering game systems.

It is therefore desired that the advantages of LCD displays be incorporated into mechanical reel slot machines.

### SUMMARY

One example embodiment of the invention comprises a computerized wagering game system including a gaming module comprising a processor and gaming code which is operable when executed on the processor to present a wagering game on which monetary value can be wagered via at least one mechanical reel and a liquid crystal display (LCD). The liquid crystal display has at least one transparent portion through which the mechanical reel or reels can be observed. A light source is configured to illuminate a back side of the at least one transparent portion of the LCD panel, selectively highlighting images shown on the transparent portion or portions of the LCD display panel.

### BRIEF DESCRIPTION OF THE FIGURES

FIG. 1 shows a computerized wagering game machine, as may be used to practice some example embodiments of the invention.

FIG. 2 shows a side view of a mechanical reel slot machine having an LCD display panel with a transparent region and transparent region backlight with reflectors, consistent with some example embodiments of the invention.

FIG. 3 shows an LCD panel wherein the LCD panel backlights are configured to backlight transparent portions of the LCD panel, consistent with some example embodiments of the invention.

FIG. 4 shows a diagram of a wagering game system with a LCD display panel having a transparent portion illuminated by a light comprising a light source and a light pipe, consistent with some example embodiments of the invention.

FIG. 5 shows a wagering game system with an LCD display panel having a transparent region illuminated by lamps and a reflective screen, consistent with some example embodiments of the invention.

FIG. 6 shows a wagering game system with an LCD display panel having a transparent region illuminated by lamps at the edge of the transparent region cutout, consistent with some example embodiments of the invention.

FIG. 7 is a flowchart of a method of practicing one example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

One example embodiment of the invention comprises a computerized wagering game system includes a gaming module comprising a processor and gaming code which is operable when executed on the processor to present a wagering game on which monetary value can be wagered via at least one mechanical reel and a liquid crystal display (LCD). The liquid crystal display has at least one transparent portion through which the mechanical reel or reels can be observed. A light source is configured to illuminate a back side of the at least one transparent portion of the LCD panel, selectively highlighting images shown on the transparent portion or portions of the LCD display panel.

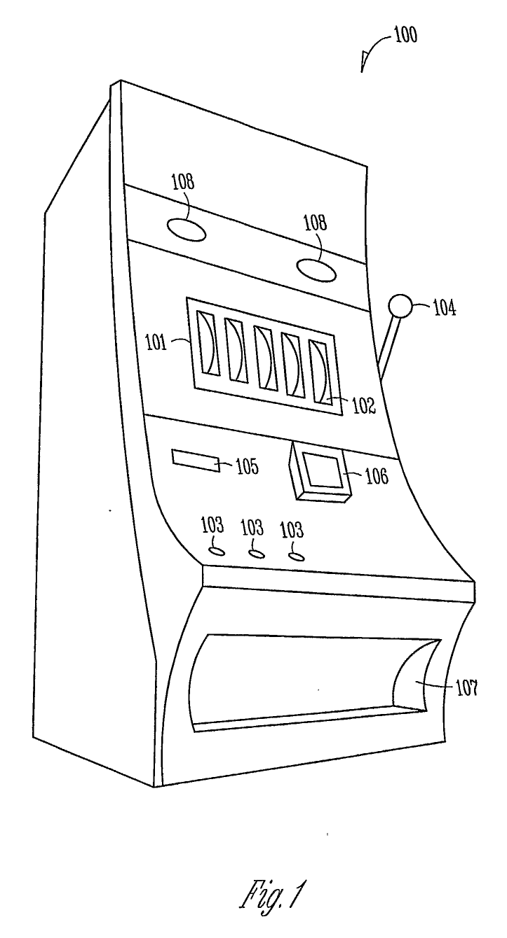

FIG. 1 illustrates a computerized wagering game machine, as may be used to practice some embodiments of the present invention. The computerized gaming system shown generally at 100 is a video wagering game system, which displays information for at least one wagering game upon which monetary value can be wagered on video display 101. Video display 101 is in some embodiments an LCD display having a transparent region that can be seen through, but which is still an active display area. This can be achieved by removing the reflective back layer of a typical LCD display panel in the transparent region, along with other layers behind the liquid crystal layer such as the backlight diffusion layer and any back enclosure material. In other embodiments, a surface conducting electron emitter display, plasma display, or any other type of display suitable for displaying electronically provided display information is used as long as it can be configured to have a semitransparent portion. The wagering game also features a mechanical game element that can be seen through the transparent portions of the liquid crystal display under some circumstances, such as mechanical reels visible through the transparent regions of the display at 102 that comprise a part of a video slot machine wagering game.

A wagering game is implemented using software within the wagering game system, such as through instructions stored on a machine-readable medium such as a hard disk drive or nonvolatile memory. In some further example embodiments, some or all of the software stored in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered. The wagering game implemented via the loaded software takes various forms in different wagering game machines, but is in most example embodiments discussed herein a traditional reel slot game using mechanical reels visible through the transparent portions of the liquid crystal display. Other wagering games such as video poker, blackjack, craps, roulette, or hold 'em games that use mechanical elements can be used in a similar manner in further examples. The wagering game is played and controlled with inputs such as various buttons 103 or via a touchscreen overlay to video screen 101. In some alternate examples, other devices such as pull arm 104 used to initiate reel spin in this reel slot machine example are employed to provide other input interfaces to the game player.

Monetary value is typically wagered on the outcome of the games, such as with tokens, coins, bills, or cards that hold monetary value. The wagered value is conveyed to the machine through a changer 105 or a secure user identification module interface 106, and winnings are returned via the returned value card or through the coin tray 107. Sound is also provided through speakers 108, typically including audio indicators of game play, such as reel spins, credit bang-ups, and environmental or other sound effects or music to provide entertainment consistent with a theme of the computerized wagering game. The wagering game system takes alternate forms in other embodiments, such as a wireless portable wagering game system, or a user-supplied device operable to present a wagering game conducted remotely such as on a server. In some further embodiments, the wagering game machine is coupled to a network, and is operable to use its network connection to receive wagering game data, track players and monetary value associated with a player, and to perform other such functions.

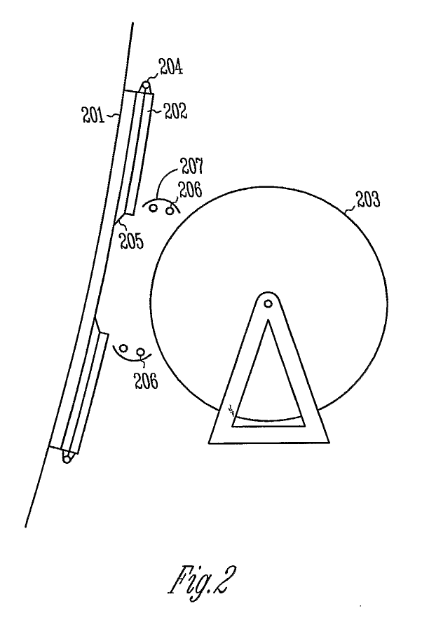

A more detailed view of a liquid crystal display panel and mechanical reel slots is shown in FIG. 2, consistent with an example embodiment of the invention. The touchscreen liquid crystal display (LCD) panel 201 comprises several layers, including a back reflective layer 202. The back reflective layer 202 is removed from the LCD panel assembly in a region as shown in FIG. 2, so that the front face of the slot machine reel 203 can be easily seen through the LCD panel.

The LCD panel remains operational in this region, and is able to superimpose graphics over the visible reels behind the LCD panel. Each pixel in a typical LCD panel comprises a liquid crystal suspended between two polarizing filters with axes that are perpendicular to each other. In the absence of the liquid crystal presence, light passing through one polarized filter would not be able to pass through the other due to the difference in polarization direction. The liquid crystal element changes the polarization of light that has passed through the first polarizing filter so that its polarization has changed and it can pass through the second polarizing filter.

When an electrical charge is applied to a liquid crystal element in a liquid crystal display pixel, the natural twist of the liquid crystal is undone to a degree dependent on the charge applied as the liquid crystals align themselves parallel to the electric field, thereby reducing the change in polarization by a varying amount and blocking light from passing through both the first and second polarizing filters to a variable degree.

While some LCD displays such as those used in pocket calculators and wristwatches are simply reflective, and use ambient light reflected off a reflective backplane such as back reflective layer 202, most are transmissive panels that are lit via one or more backlights 204, such as are commonly found in LCD computer monitors and cellular telephones. These transmissive LCD panels rely on backlighting, which is usually distributed across the face of the liquid crystal display panel by a light carrying layer called a diffusion layer 205 that carries and diffuses light injected from the sides of the panel to ensure uniform illumination of the transmissive LCD panel.

This principle can be used to create a color display by using a red, green, and blue subpixel for each pixel location, so that a full color spectrum can be displayed for each pixel by varying the amount of these three light primary colors that is visible. This is done by varying the voltages applied to each of the three colored subpixels, thereby varying the amount of colored light from the backlight diffuser layer of the display panel that reaches the viewer.

The back side of the liquid crystal display panel is therefore almost always an opaque surface designed to reflect light, to illuminate the display pane. In some embodiments of the invention such as are shown in FIG. 2, the back reflective coating is removed from a portion of the LCD display panel, allowing light to pass through the panel when the LCD elements are not energized. As FIG. 2 shows, a mechanical element such as a slot machine reel placed behind the LCD display panel is then visible, resulting in a display that allows both presentation of computer graphics or video and of a mechanical element located behind the portion of the LCD display panel that lacks a reflective backing.

The slot machine assembly of FIG. 2 therefore includes one or more lights 206 configured to illuminate the non-viewing surface, or back side of the LCD display panel, so that graphics or video displayed on the portion of the LCD display panel that has some transparency due to lack of a reflective back coating are still brightly lit and clearly visible. The lights 206 in the example shown in FIG. 2 are located within reflectors 207 such that they are configured to focus light on the transparent region of the LCD display panel. The lights 206 can be selectively turned off, and in a further embodiment other lights configured in a different location within the reflector can be turned on to focus light on the reel surface. This enables selective enhancement of visibility of either the surface of mechanical reel 203 visible within the transparent region of the LCD display panel, or of graphics or video shown on the transparent portion of the LCD display panel.

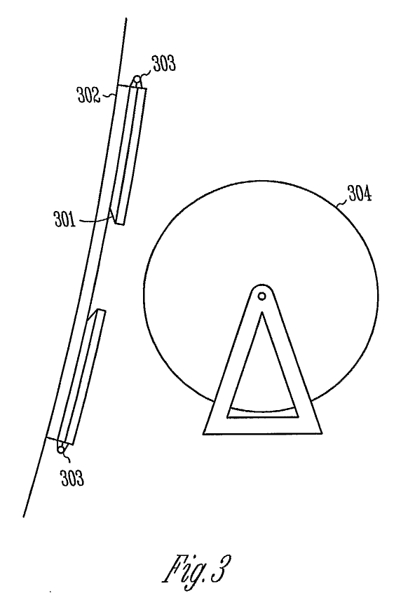

In another example embodiment shown in FIG. 3, the backlight lights themselves are used to illuminate the back of the transparent region of the LCD display panel 302. The diffusion layer 301 is cut away in the transparent region, and is beveled toward the rear surface of the LCD display panel. Light from backlights 303 reaching the beveled edge of the diffusion layer 301 is therefore projected toward the back of the LCD display panel 302, resulting in a brighter and easier to see graphic or video image on the transparent portion of the LCD display panel.

In an alternate embodiment, the diffusion layer 302 which is located between the LCD display pixel elements and the back reflective layer serves its normal backlight function, and an additional backlight layer is located behind the reflective backing of the LCD display panel to carry light and project it onto the transparent portion of the LCD display panel much as the diffusion layer 301 is configured to do in FIG. 3. The additional backlight layer is lit in some embodiments by the same backlight lamps 303 as the diffusive layer 301 in the LCD display panel, while in other embodiments it is lit by other lights or by both the backlight lamps 303 and other light sources.

The transparent section is lit selectively in some examples, so that the light can be turned off to allow easier viewing of the mechanical slot reel 304 or turned on to obscure the reel and make the image shown on the transparent portion of the LCD display panel more distinct.

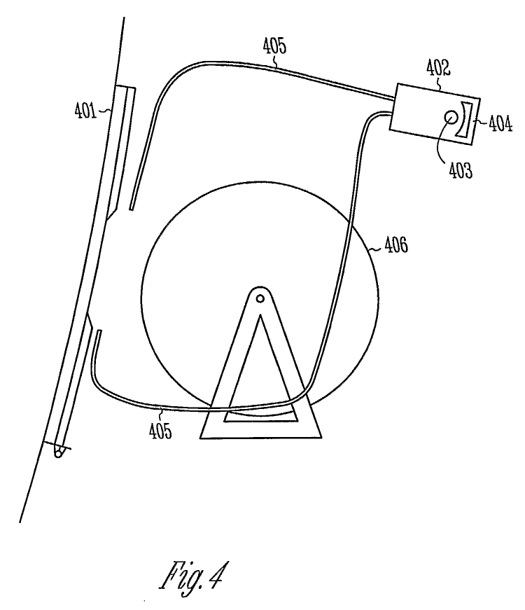

FIG. 4 shows a diagram of a wagering game system with a LCD display panel having a transparent portion illuminated by a light comprising a light source and a light pipe. The LCD display panel 401 is backlit in the transparent region by light from a light box 402 including a lamp or light source 403 and a reflector 404, designed to produce light that can be carried by light pipes or fiber optic light conductors 405. The light pipes are configured to illuminate the rear side of the transparent portion of the LCD display panel 401, and in a further embodiment can be selectively shut off and turned on to vary the amount of illumination or to selectively highlight the graphics or video being displayed on the transparent portion of the LCD display panel.

In a further embodiment, the light box 402 and light pipes such as 405 are used to light other portions of the wagering game system, such as to backlight the LCD display panel 401's diffusion or illumination layer, or to selectively illuminate the mechanical reels 406 of the mechanical reel slot game. The light pipes illuminating the slot reels and the light pipes illuminating the back of the transparent area of the LCD display panel 401 can be lit alternately such as by using electronically controllable LCD shutters or other technology to control the amount of light distributed through each light pipe, enabling the wagering game system to selectively highlight either the slot reel 406 or the image displayed on the LCD display panel 401 at various times during game play.

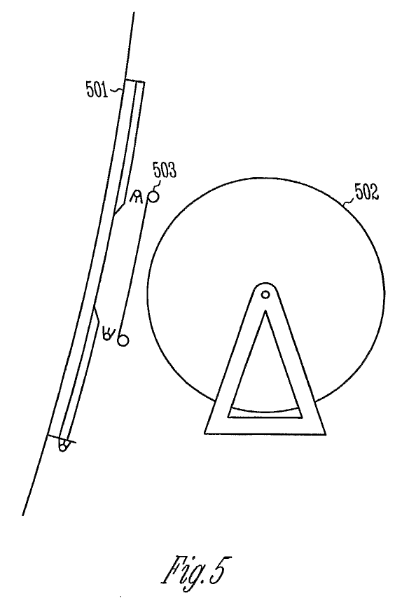

FIG. 5 shows a wagering game system with an LCD display panel having a transparent region illuminated by lamps and a reflective screen. The LCD display panel 501 has a transparent portion that enables the slot machine mechanical reels 502 to be seen through the display, and a reflective screen 503 that is configurable to either shield the slot reel surface with a reflective material so that it cannot be seen through the transparent region of the display, or to be transparent so that the slot reel is clearly visible through the transparent region of the display.

The screen 503 shown in FIG. 5 is a screen on rollers that can be actuated, so that a transparent part of the screen can be rolled from between the slot reel 502 and the transparent portion of the LCD display screen 501 and replaced with a reflective portion of the screen.

The screen material rolls up on the rollers, much like a retractable roll-up movie screen. In other embodiments, the screen is a drop-down screen or is mechanically inserted ,but remains an illuminated screen with reflective properties operable to reflect light onto the back side of the LCD display panel to illuminate an image or graphics displayed on the panel.

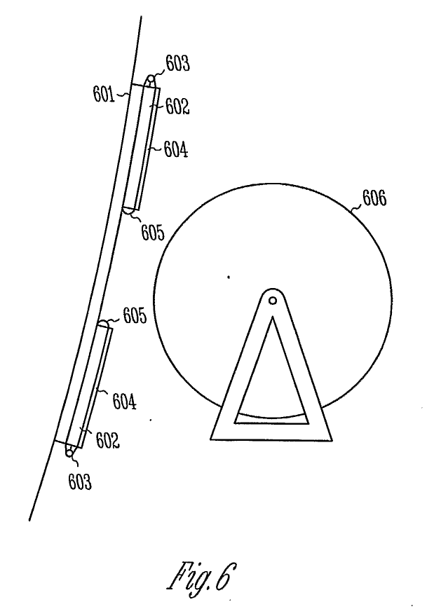

FIG. 6 illustrates another example method of illuminating the back of a transparent portion of an LCD panel, using a light mounted at the LCD panel cutout that forms the transparent portion. The LCD panel 610 has a backlight or dispersive layer 602 that is operable to carry backlight from lights 603 to backlight the LCD panel 601. The backlight layer 602 also has an opaque or reflective layer 604, used to prevent light from entering or exiting through the back of the LCD display, ensuring even illumination. Transparent portion lights 605 are configured at the edge of the cutout in the backlight layer 602 and opaque layer 604, and are selectively actuated to light the back side of the transparent portion of the LCD display.

In some embodiments, the transparent portion lights 605 are directed toward the back side of the transparent portion of the display, such as by use of light-emitting diode elements with lenses oriented to focus the light produced toward the back side of the transparent portion. In other embodiments, the light produced by lights 605 is directed toward the reel strip 606, or toward a screen or baffle such as screen 503 of FIG. 5.

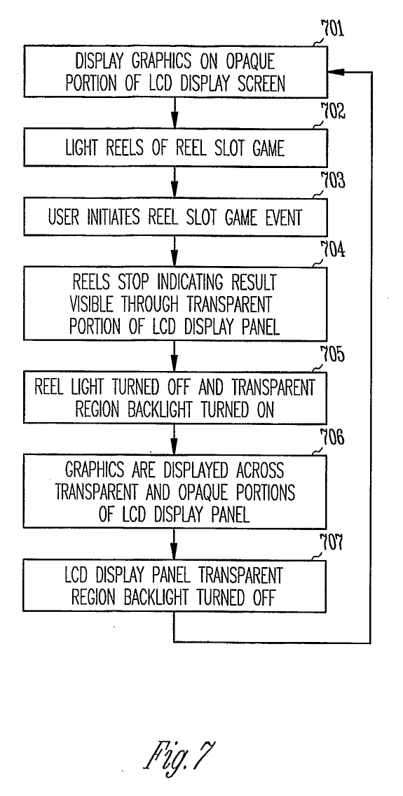

FIG. 7 is a flowchart of one example method of practicing the invention. At 701, the computerized wagering game system displays graphics on the opaque portion of the LCD display screen, while the transparent portion of the screen remains blank. If the reels are not already lit, the mechanical reels of the slot machine wagering game are lit at 702, making the reels clearly visible through the transparent region of the LCD display.

The user initiates a reel slot game event at 703, such as by pushing a play button or pulling a lever arm. The reels spin, and at 704 the reels stop one at a time with predetermined reel symbols facing forward and visible through the transparent portions of the LCD panel, indicating the result of the wagering game play.

Once sufficient time has passed for the results of the wagering game play to be observed, the wagering game system turns off the light configured to illuminate the reels, and turns on a light configured to illuminate the back side of the transparent portion of the LCD display panel at 705. Graphics or video can then be displayed and easily viewed across the entire LCD display panel at 706, including both the transparent and opaque portions of the panel. The change in lighting from light directed at the slot reels to light directed at the back of the transparent portion of the LCD display panel reduces the visibility of the slot reels, and increases the light shining on the back of the transparent portion of the LCD display panel, making the graphics or video displayed on the transparent portion of the LCD display panel more prominent.

Once the graphics displayed on the transparent portion of the LCD display screen are complete and the player's focus is to return to the slot reels, the light illuminating the back side of the transparent portion of the LCD display panel is turned off at 707. Graphics can be displayed on the opaque portion of the LCD display panel again at 701, and the reels are again visible when the slot reel light is reilluminated again at 702. In other wagering game systems, illumination of the back portion of the LCD display panel is triggered by various events, or is constant. The examples presented here illustrate how illuminating the back side of a transparent portion of an LCD display panel can be used to increase visibility of graphics or video displayed on the transparent portion of the display panel. Some examples further show how the light can be turned on and off, or alternated with a light illuminating a mechanical game element such as the reels of a mechanical reel slot machine, to emphasize either the slot reels or the image displayed on the LCD display panel. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A computerized wagering game system, comprising:
a gaming module comprising a processor and gaming code which is operable when executed on the processor to present a wagering game on which monetary value can be wagered via at least one mechanical reel;
a liquid crystal display (LCD) having at least one transparent portion through which the at least one mechanical reel can be observed; and
a light source configured to illuminate a back side of the at least one transparent portion of the LCD panel.

2. The computerized wagering game system of claim 1, further comprising a light controller operable to selectively actuate the light source such that it is turned on to highlight an image on the transparent portion of the LCD and turned off to highlight the at least one mechanical reel visible through the transparent portion of the LCD.

3. The computerized wagering game system of claim 1, further comprising a reflector operable to direct light from the light source to the back side of the at least one transparent portion of the LCD panel

4. The computerized wagering game system of claim 1, wherein the light source comprises at least one of an incandescent lamp, a fluorescent lamp, a cold-cathode lamp, or a light-emitting diode.

5. The computerized wagering game system of claim 1, further comprising an opaque screen selectively movable between the LCD panel and the at least one mechanical reel such that the light source is operable to illuminate the back side of the at least one transparent portion of the LCD panel by reflecting light off the screen onto the back side of the LCD panel.

6. The computerized wagering game system of claim 1, wherein the light source is configured to illuminate a back side of the at least one transparent portion of the LCD panel by transmission of the light through a layer of the LCD panel.

7. The computerized wagering game system of claim 1, wherein the light source configured to illuminate the back side of the at least one transparent portion of the LCD panel comprises an optically transparent light pipe configured to conduct light form the light source to the back side of the at least one transparent portion of the LCD panel.

8. A method of operating a computerized wagering game system, comprising:
presenting a wagering game on which monetary value can be wagered via at least one mechanical reel;
displaying an image on a liquid crystal display (LCD) having at least one transparent portion through which the at least one mechanical reel can be observed; and
illuminating a back side of the at least one transparent portion of the LCD panel via a light source.

9. The method of claim 8, wherein illuminating the back side of the LCD panel is selective such that the light source is turned on to highlight an image on the transparent portion of the LCD and turned off to highlight the at least one mechanical reel visible through the transparent portion of the LCD.

10. The method of claim 8, wherein illuminating the back side of the LCD panel via a light source occurs via reflector operable to direct light from the light source to the back side of the at least one transparent portion of the LCD panel

11. The method of claim 8, wherein the light source comprises at least one of an incandescent lamp, a fluorescent lamp, a cold-cathode lamp, or a light-emitting diode.

12. The method of claim 8, wherein illuminating the back side of the LCD panel via a light source comprises illuminating an opaque screen selectively movable between the LCD panel and the at least one mechanical reel such that the light source is operable to illuminate the back side of the at least one transparent portion of the LCD panel by reflecting light off the screen onto the back side of the LCD panel.

13. The method of claim 8, wherein illuminating a back side of the at least one transparent portion of the LCD panel occurs by transmission of the light through a layer of the LCD panel.

14. The method of claim 8, wherein the light source configured to illuminate the back side of the at least one transparent portion of the LCD panel comprises an optically transparent light pipe configured to conduct light form the light source to the back side of the at least one transparent portion of the LCD panel.

15. A display panel apparatus, comprising:
a display panel having at least one transparent portion through which the at least one object can be observed; and
a light source configured to illuminate a back side of the at least one transparent portion of the display panel.

16. The display panel apparatus of claim 15, wherein the at least one object comprises a wagering game object.

17. The display panel apparatus of claim 15, wherein the display panel comprises a liquid crystal display, plasma, surface conduction electron emission display, field emission display, or organic light emitting diode display.

18. The display panel apparatus of claim 15, wherein the light source is operable to be selectively actuated such that it is turned on to highlight an image on the display and turned off to highlight the at least one object observable through the at least one transparent portion of the display panel.

19. The display panel apparatus of claim 15, further comprising a reflector operable to direct light from the light source to the back side of the at least one transparent portion of the display panel

20. The computerized display panel apparatus of claim 15, wherein the light source comprises at least one of an incandescent lamp, a fluorescent lamp, a cold-cathode lamp, or a light-emitting diode.
